(19) United States
(12) Patent Application Publication
(10) Pub. No.: US 2025/0265183 A1
(43) Pub. Date: Aug. 21, 2025

(54) MEMORY-EFFICIENT ENCODING AND DECODING OF BOUNDARY CONDITIONS IN THE LATTICE BOLTZMANN METHOD

(71) Applicant: Autodesk, Inc., San Francisco, CA (US)

(72) Inventors: Mohammadmehdi Ataei, Toronto (CA); Massimiliano Meneghin, Tambre (IT); Hesam Salehipour, Richmond Hill (CA)

(21) Appl. No.: 19/040,731

(22) Filed: Jan. 29, 2025

Related U.S. Application Data
(60) Provisional application No. 63/556,329, filed on Feb. 21, 2024.

(51) Int. Cl. G06F 12/02

(52) U.S. Cl. CPC G06F 12/023; G06F 2212/251

(57) ABSTRACT

Methods, systems, and apparatus, including medium-encoded computer program products include: receiving an allocation of storage locations in a first memory, where the storage locations are used for storing representations of particle populations for respective lattice units of a discretized space, where the first memory is a random access memory of a processing system; receiving boundary conditions data; encoding the boundary condition data in unused portions of the storage locations of the first memory during at least one time step of a lattice Boltzmann modelling process; providing the boundary conditions data from the first memory to a second memory for applying, in the second memory, the boundary conditions at the one or more boundaries during the at least one time step, where the second memory is a local memory of the processing system; and providing a result of the at least one time step of the lattice Boltzmann modelling process.

### CROSS-REFERENCE TO RELATED APPLICATIONS

This application claims the benefit of priority of U.S. Patent Application No. 63/556,329, entitled “MEMORY-EFFICIENT ENCODING AND DECODING OF BOUNDARY CONDITIONS IN THE LATTICE BOLTZMANN METHOD”, filed Feb. 21, 2024, the entire contents of which are hereby incorporated by reference.

### BACKGROUND

This specification relates to memory management in processing systems, and in particular, memory management during encoding and decoding of boundary conditions in the implementation of lattice Boltzmann methods.

The lattice Boltzmann method is a widely used technique in computational fluid dynamics. The lattice Boltzmann method is particularly well-suited for implementation on Graphics Processing Units (GPUs) due to its regular and localized data access patterns leading to a high degree of parallelism. However, lattice Boltzmann is inherently memory-bound, which poses challenges for its adaptation for implementation on modern computer architectures. Memory management becomes especially critical when implementing complex boundary conditions, which introduce additional memory requirements. This added complexity may also hinder data locality and can make performance optimization techniques, such as kernel fusion, impractical or challenging to implement.

### SUMMARY

This specification describes technologies relating to memory management in processing systems, and in particular to memory-efficient encoding and decoding of boundary conditions in the implementation of lattice Boltzmann methods.

In general, one or more aspects of the subject matter described in this specification can be embodied in one or more methods (and also one or more non-transitory computer-readable mediums tangibly encoding instructions that, when executed, cause one or more processors to perform method operations), including: receiving an allocation of storage locations in a first memory, wherein the storage locations are used for storing representations of particle populations for respective lattice units of a discretized space, each particle population representation corresponding to each of a predetermined number of lattice vectors associated with different lattice directions, wherein the first memory is a random access memory of a processing system, and the lattice units include boundary lattice units at one or more boundaries of the discretized space; receiving boundary conditions data about one or more boundary conditions to be applied to the one or more boundaries of the discretized space; encoding the boundary condition data in unused portions of the storage locations of the first memory that have been allocated for storing (i) outgoing populations of the boundary lattice units that will not be requested from the first memory or (ii) incoming populations of the boundary lattice units that will be missing in the first memory, during at least one time step of a lattice Boltzmann modelling process; providing the boundary conditions data from the first memory to a second memory for applying, in the second memory, the boundary conditions at the one or more boundaries during the at least one time step of the lattice Boltzmann modelling process, wherein the second memory is a local memory of the processing system; and providing a result of the at least one time step of the lattice Boltzmann modelling process, wherein the at least one time step includes the applying the boundary conditions, a collision operation, and a streaming operation.

These and other aspects can each, optionally, include one or more of the following features. The boundary conditions data can include a vector indicating a location of a wall and a value of a pressure or velocity to be applied at the wall. Encoding the boundary conditions data in the unused portions of the storage locations of the first memory can include encoding, in a first portion allocated for storing a first outgoing population of a boundary lattice unit, the value of the pressure or velocity to be applied at the wall.

Encoding the boundary conditions data in unused portions of the storage locations of the first memory can include encoding, in a second portion allocated for storing a second outgoing population of a boundary lattice unit, indices corresponding to lattice vectors of outgoing populations and at least one index corresponding to directions of mid-plane populations.

Providing the boundary conditions data from the first memory to the second memory for applying, in the second memory, the boundary conditions at the one or more boundaries during the at least one step of the lattice Boltzmann modelling process can include decoding, from the first portion, the value of the pressure or velocity, and decoding, from the second portion, based on the encoded indices, indices corresponding to outgoing populations, mid-plane populations, and incoming populations.

The boundary conditions data can include components of a velocity vector of a wall and/or distances to the wall for each lattice vector corresponding to a missing population. Encoding the boundary conditions data in unused portions of the storage locations of the first memory can include storing, in storage locations allocated for storing the outgoing populations, the components of the velocity vector and the distances to the wall.

The components of the velocity vector of the wall and the distances to the wall can be encoded using fixed-point arithmetic with a precision lower than a precision used for the at least one step of the lattice Boltzmann modelling process.

Encoding, in unused allocated storage locations of the first memory, boundary conditions data can include encoding, for the at least one time step of the lattice Boltzmann modelling process, post-collision population values obtained after a collision operation of a previous time step of the lattice Boltzmann modelling process.

Applying the boundary conditions at the one or more boundaries during the at least one time step of the lattice Boltzmann modelling process can include applying the boundary conditions based on the post-collision population values obtained during the previous time step and post-collision values obtained during the at least one time step.

During the at least one time step of the lattice Boltzmann modelling process, the applying the boundary conditions, the collision operation, and the streaming operation can be performed together by a computational kernel that merges boundary condition handling with collision and streaming operations.

The lattice Boltzmann modelling process can be used in a computational fluid dynamics process. The provided result can include a fluid density evolution in the discretized space.

The local memory can be close enough to a processor of the processing system so that the memory is connected to a system bus of an integrated circuit chip on or in which the processor is built. The local memory can include a register memory or a cache memory of the processing system. The processing system can include multiple GPUs. The second memory can include thread registers of the multiple GPUs.

One or more aspects of the subject matter described in this specification can also be embodied in one or more systems including: one or more processors; a random access memory coupled with the one or more processors; and a local memory coupled with the one or more processors. The one or more processors can be configured to: receive an allocation of storage locations in the random access memory, wherein the storage locations are used for storing representations of particle populations for respective lattice units of a discretized space, each particle population representation corresponding to each of a predetermined number of lattice vectors associated with different lattice directions, wherein the lattice units include boundary lattice units at one or more boundaries of the discretized space; receive boundary conditions data about one or more boundary conditions to be applied to the one or more boundaries of the discretized space; encode the boundary condition data in unused portions of the storage locations of the random access memory that have been allocated for storing (i) outgoing populations of the boundary lattice units that will not be requested from the random access memory or (ii) incoming populations of the boundary lattice units that will be missing in the random access memory, during at least one time step of a lattice Boltzmann modelling process; provide the boundary conditions data from the random access memory to the local memory for applying, in the local memory, the boundary conditions at the one or more boundaries during the at least one time step of the lattice Boltzmann modelling process; and provide a result of the at least one time step of the lattice Boltzmann modelling process, wherein the at least one time step includes the applying the boundary conditions, a collision operation, and a streaming operation.

These and other aspects can each, optionally, include one or more of the following features. The boundary conditions data can include a vector indicating a location of a wall and a value of a pressure or velocity to be applied at the wall. The one or more processors can be configured to encode, in a first portion allocated for storing a first outgoing population of a boundary lattice unit, the value of the pressure or velocity to be applied at the wall.

The one or more processors can be configured to encode, in a second portion allocated for storing a second outgoing population of a boundary lattice unit, indices corresponding to lattice vectors of outgoing populations and at least one index corresponding to directions of mid-plane populations.

The one or more processors can be configured to provide the boundary conditions data from the random access memory to the local memory for applying, in the local memory, the boundary conditions at the one or more boundaries during the at least one step of the lattice Boltzmann modelling process by being configured to decode, from the first portion, the value of the pressure or velocity, and decode, from the second portion, based on the encoded indices, indices corresponding to outgoing populations, mid-plane populations, and incoming populations.

The boundary conditions data can include components of a velocity vector of a wall and/or distances to the wall for each lattice vector corresponding to a missing population. The one or more processors can be configured to encode the boundary conditions data in unused portions of the storage locations of the first memory by being configured to store, in storage locations allocated for storing the outgoing populations, the components of the velocity vector and the distances to the wall.

The components of the velocity vector of the wall and the distances to the wall can be encoded using fixed-point arithmetic with a precision lower than a precision used for the at least one step of the lattice Boltzmann modelling process.

The one or more processors can be configured to encode, in unused allocated storage locations of the first memory, boundary conditions data by being configured to encode, for the at least one time step of the lattice Boltzmann modelling process, post-collision population values obtained after a collision operation of a previous time step of the lattice Boltzmann modelling process.

Applying the boundary conditions at the one or more boundaries during the at least one time step of the lattice Boltzmann modelling process can include applying the boundary conditions based on the post-collision population values obtained during the previous time step and post-collision values obtained during the at least one time step.

During the at least one time step of the lattice Boltzmann modelling process, the applying the boundary conditions, the collision operation, and the streaming operation can be performed together by a computational kernel that merges boundary condition handling with collision and streaming operations.

The lattice Boltzmann modelling process can be used in a computational fluid dynamics process. The provided result can include a fluid density evolution in the discretized space.

The local memory can be close enough to at least one or more processors of the processing system so that the local memory is connected to a system bus of an integrated circuit chip on or in which the at least one of the one or more processors is built. The local memory can include a register memory or a cache memory of the one or more processors. The one or more processors can include multiple GPUs. The local memory can include thread registers of the multiple GPUs.

Particular embodiments of the subject matter described in this specification can be implemented to realize one or more of the following advantages. The described memory management techniques reduce the memory requirements of boundary conditions in lattice Boltzmann modelling processes. Unused but allocated memory can be leveraged to efficiently store boundary conditions data. The memory overhead associated with complex boundary conditions can be reduced or eliminated. The described memory management techniques also enable effective application of performance optimization techniques, such as kernel fusion, thus improving the overall performance of lattice Boltzmann modelling processes. The described memory management techniques can be implemented on CPU (Central Processing Unit) and/or GPU (Graphics Processing Unit) systems.

Further, the described lattice Boltzmann methods can be applied to computational fluid dynamics processes in several physics domains, e.g., thermal, multiphysics, etc. The results of such processes can be used as input to computer aided manufacturing systems to manufacture three-dimensional structures using additive manufacturing, subtractive manufacturing and/or other manufacturing systems and techniques and/or can be provided as a digital asset, such as for use in animation.

The details of one or more embodiments of the subject matter described in this specification are set forth in the accompanying drawings and the description below. Other features, aspects, and advantages of the invention will become apparent from the description, the drawings, and the claims.

### BRIEF DESCRIPTION OF THE DRAWINGS

FIG. 1 shows an example of a system usable to facilitate implementation of the described memory management techniques in a lattice Boltzmann modelling process.

FIG. 2 is an example of a two-dimensional discretized space for lattice Boltzmann process modeling.

FIG. 3 is a flowchart of an example of a lattice Boltzmann modelling process with boundary condition memory management.

FIG. 4A is an example of implementation of one time step of a lattice Boltzmann modelling process with boundary condition memory management using a “pull” method.

FIG. 4B is an example of implementation of one time step of a lattice Boltzmann modelling process with boundary condition memory management using a “push” method.

FIG. 5 shows a comparison of memory requirements for a lattice Boltzmann method for a given simulation using different boundary condition storage methods

FIG. 6 shows an example of an encoding method for pressure or velocity boundary conditions at straight open boundaries.

FIG. 7 shows an example of a curved solid boundary where an interpolating bounce-back boundary condition can be imposed.

FIG. 8 shows flowcharts of lattice Boltzmann modelling processes for different boundary conditions.

FIG. 9 is a schematic diagram of a data processing system including a data processing apparatus, which can be programmed as a client or as a server, and implement the techniques described in this document.

Like reference numbers and designations in the various drawings indicate like elements.

### DETAILED DESCRIPTION

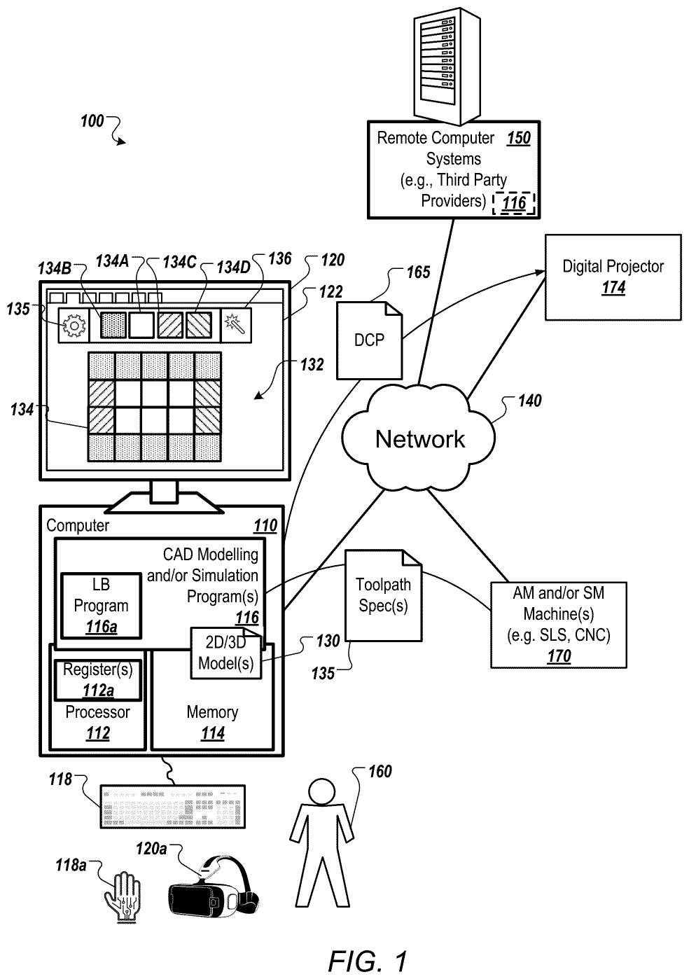

FIG. 1 shows an example of a system 100 usable to facilitate implementation of the described memory management techniques in a lattice Boltzmann modelling process. A computer 110 includes a processor 112 and a memory 114, and the computer 110 can be connected to a network 140, which can be a private network, a public network, a virtual private network, etc. The processor 112 can be one or more hardware processors, which can each include multiple processor cores. The memory 114 can include both volatile and non-volatile memory, such as Random Access Memory (RAM) and Flash RAM. The computer 110 can include various types of computer storage media and devices, which can include the memory 114, to store instructions of programs that run on the processor 112, including CAD modelling and/or simulation program(s) 116, which include a program 116a, such as a lattice Boltzmann (LB) program that includes efficient encoding/decoding of boundary conditions in a lattice Boltzmann modelling process as described.

In some instances, numerical simulation performed by the systems and techniques described in this document can simulate one or more physical properties to produce a numerical assessment of a physical response of a modeled object. Further, the simulation of physical properties can include Computational Fluid Dynamics (CFD), Acoustics/Noise Control, thermal conduction, computational injection molding, electric or electro-magnetic flux, and/or material solidification (which is useful for phase changes in molding processes) simulations.

As used herein, CAD refers to any suitable program used to design physical structures that meet design requirements, regardless of whether or not the program is capable of interfacing with and/or controlling manufacturing equipment. Thus, CAD program(s) 116 can include Computer Aided Engineering (CAE) program(s), Computer Aided Manufacturing (CAM) program(s), etc. The program(s) 116 can run locally on computer 110, remotely on a computer of one or more remote computer systems 150 (e.g., one or more third party providers' one or more server systems accessible by the computer 110 via the network 140) or both locally and remotely. Thus, a program 116 can be two or more programs that operate cooperatively on two or more separate computer processors in that one or more programs 116 operating locally at computer 110 can offload processing operations (e.g., lattice Boltzmann modelling and/or physical simulation operations) “to the cloud” by having one or more programs 116 on one or more computers 150 perform the offloaded processing operations. In some implementations, all lattice Boltzmann modelling and/or simulation operations are run by one or more programs in the cloud and not in a geometry representation modeler that runs on the local computer. Moreover, in some implementations, the lattice Boltzmann modelling and/or simulation program(s) can be run in the cloud from an Application Program Interface (API) that is called by a program, without user input through a graphical user interface.

The CAD modelling and simulation program(s) 116 present a user interface (UI) 122 on a display device 120 of the computer 110, which can be operated using one or more input devices 118 of the computer 110 (e.g., keyboard and mouse). Note that while shown as separate devices in FIG. 1A, the display device 120 and/or input devices 118 can also be integrated with each other and/or with the computer 110, such as in a tablet computer (e.g., a touch screen can be an input/output device 118, 120). Moreover, the computer 110 can include or be part of a virtual reality (VR) and/or augmented reality (AR) system. For example, the input/output devices 118, and 120 can include VR/AR input controllers, gloves, or other hand manipulating tools 118a, and/or a VR/AR headset 120a. In some instances, the input/output devices can include hand-tracking devices that are based on sensors that track movement and recreate interaction as if performed with a physical input device. In some implementations, VR and/or AR devices can be standalone devices that may not need to be connected to the computer 110. The VR and/or AR devices can be standalone devices that have processing capabilities and/or an integrated computer such as the computer 110, for example, with input/output hardware components such as controllers, sensors, detectors, etc.

In any case, a user 160 can interact with the program(s) 116 to generate and/or optimize 3D model(s), which can be stored in model document(s) 130. The user 160 can interact with program 116a to perform lattice Boltzmann modelling processes as described. In the example shown in FIG. 1, a 2D or a 3D model 132 includes a discretized space 134 including lattice units to perform a lattice Boltzmann modelling process.

The user or a program can set up 135 the lattice Boltzmann modelling process. For example, the user or a program can select 135 a CPU (Central Processing Unit) or a GPU (Graphics Processing Unit) implementation. The user or a program can select 135 using multiple GPUs, for example, using, as a local memory, thread registers of the multiple GPUs. The user or a program can select 136 whether to use kernel fusion. Kernel fusion (or loop fusion) is an optimization technique commonly employed in high-performance computing. Kernel fusion combines multiple tasks or “kernels” into a single one. This reduces kernel launch overhead and potentially also the number of load and store memory operations. In the context of lattice Boltzmann methods, kernel fusion can merge into a single computational kernel the three stages of the lattice Boltzmann algorithm, namely collision, streaming, and application of boundary conditions. As a result, a fused lattice Boltzmann kernel can halve the number of load and store memory operations per iteration.

A user or a program can select a type of lattice unit for each of the lattice units of the discretized space 134. An inner/bulk lattice unit type 134A can be selected for lattice units where boundary conditions are not to be applied. Pressure or velocity boundary conditions (e.g., Zou-He boundary conditions) can be selected 134C, 134D for some of the lattice units at boundaries of the discretized space 134. No-slip boundary conditions (e.g., Bouzidi boundary conditions) at stationary or moving walls can be selected 134B for some of the lattice units at boundaries of the discretized space 134.

The lattice Boltzmann modelling or simulation process can be used to perform a simulation of a physical structure. For example, the lattice Boltzmann process can be used to perform a computational fluid dynamics simulation to optimize the physical structure design to meet physical design requirements. The resulting computer model 132 can be used to generate control instructions for manufacturing the physical structure using a manufacturing machine. Once the lattice Boltzmann modelling or simulation process has finished and the user 160 is satisfied with the result, the computer model 132 can be stored as a model document 130 and/or used to generate another representation of the model (e.g., toolpath specifications for a manufacturing process for the structure or portions thereof). This can be done upon request by the user 160, or in light of the user's request for another action, such as sending the computer model 132 to a manufacturing machine, e.g., additive manufacturing (AM) machine(s) and/or subtractive manufacturing (SM) machine(s) 170, or other manufacturing machinery, which can be directly connected to the computer 110, or connected via a network 140, as shown. This can involve a post-process carried out on the local computer 110 or externally, for example, based on invoking a cloud service running in the cloud, to further process the computer model (e.g., based on considerations associated with the additive manufacturing process) and to export the computer model to an electronic document from which to manufacture. Note that an electronic document (which for brevity will simply be referred to as a document) can be a file, but does not necessarily correspond to a file. A document may be stored in a portion of a file that holds other documents, in a single file dedicated to the document in question, or in multiple coordinated files. In addition, the user 160 can save or transmit the computer model for later use. For example, the program(s) 116 can store the document 130 that includes model 132.

The program(s) 116 can provide a document 135 (e.g., having toolpath specifications of an appropriate format) to an AM and/or SM machine 170 to produce a physical structure corresponding to at least a portion of the model 132. An AM machine 170 can employ one or more additive manufacturing techniques, such as granular techniques (e.g., Powder Bed Fusion (PBF), Selective Laser Sintering (SLS) and Direct Metal Laser Sintering (DMLS)) or extrusion techniques (e.g., Fused Filament Fabrication (FFF), metals deposition). In some cases, the AM machine 170 builds the designed object directly. In some cases, the AM machine 170 builds a mold for use in casting or forging the designed object.

A SM machine 170 can be a Computer Numerical Control (CNC) milling machine, such as a multi-axis, multi-tool milling machine used in the manufacturing process. For example, the CAD program(s) 116 can generate CNC instructions for a machine tool system 170 that includes multiple tools (e.g., solid carbide round tools of different sizes and shapes, and insert tools of different sizes that receive metal inserts to create different cutting surfaces) useable for various machining operations. Thus, in some implementations, the CAD program(s) 116 can provide a corresponding document 135 (having toolpath specifications of an appropriate format, e.g., a CNC numerical control (NC) program) to the SM machine 170 for use in manufacturing the physical structure using various cutting tools, etc.

In addition, in some implementation, no physical manufacturing is involved. The systems and techniques described herein are applicable to any suitable 3D modelling software. Thus, in some implementations, the program(s) 116 can be animation production program(s) that render the model 132 to a document 165 of an appropriate format for visual display, such as by a digital projector 174 (e.g., a digital cinema package (DCP) 165 for movie distribution) or other high resolution display device. Other applications are also possible.

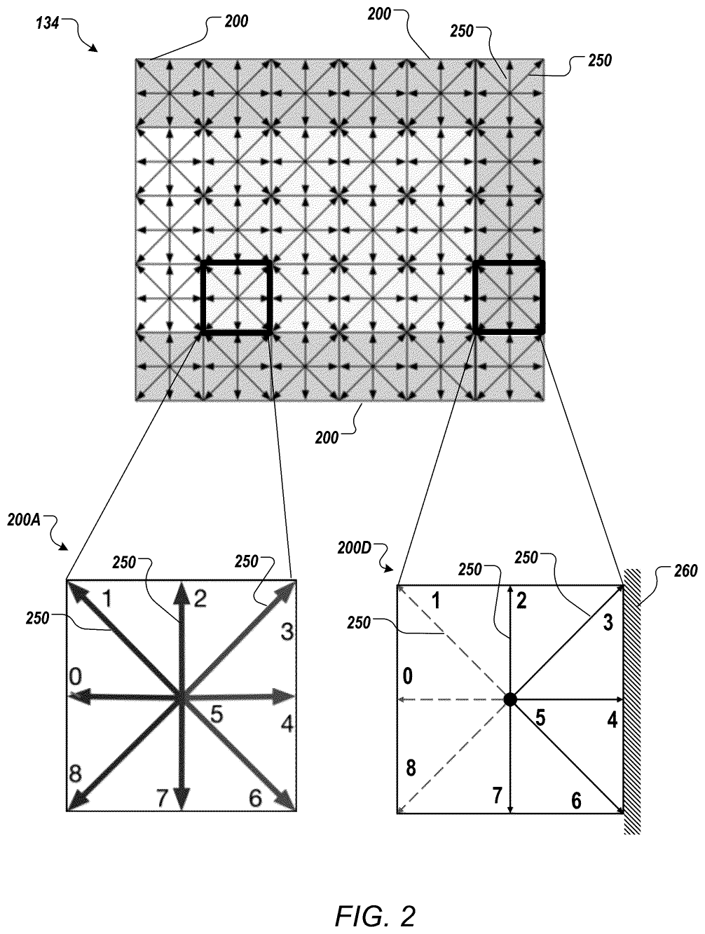

FIG. 2 is an example of a two-dimensional discretized space 134 for lattice Boltzmann process modeling. Discretized space 134 includes a plurality of lattice units 200. The lattice Boltzmann equation describes the evolution of the distribution functions or “populations” of fictitious particles as ƒᵢ(x,t+Δt)−ƒᵢ(x−eᵢΔt,t)=Ωᵢ(ƒ), where ƒᵢ(x,t) is the distribution function of particles at a position x and time t moving in an i^{th} direction that corresponds to the direction of a discrete lattice vector (also called lattice velocity vector) eᵢ. The term Ωᵢ(ƒ) is an operator that describes the collisions of fictitious the particles along that i^{th} direction.

In the example of FIG. 2, each lattice unit 200, such as inner/bulk lattice unit 200A or boundary lattice unit 200D, has nine discrete lattice vectors 250, each of them pointing in a different i^{th} direction, representing the different directions along which the fictitious particles can move. This type of two-dimensional lattice structure with nine possible lattice velocity directions is usually called a D2Q9 structure.

The implementation of the lattice Boltzmann equation involves three main steps or operations per lattice Boltzmann time step: streaming, collision, and application of boundary conditions. In the streaming step, the particles propagate along the lattice directions, and the distribution function is updated by either pulling the populations from the neighbors (i.e., the so-called “pull” method) or alternatively by pushing information to the neighbors (i.e., the so-called “push” method).

The “pull” method requires remote (x−eᵢΔt) reads and local(x) writes, ƒᵢ(x,t+Δt)=ƒᵢ*(x−eᵢΔt,t). The “push” method requires remote (x+eᵢΔt) writes and local(x) reads, ƒᵢ(x+eᵢΔt,t+Δt)=ƒᵢ*(x,t), where ƒᵢ* denotes the post-collision populations.

In the collision step, particles interact with each other and their distribution function ƒᵢ(x,t) is updated to a post-collision distribution ƒᵢ*(x,t) based on the collision operator Ωᵢ(ƒ). Without loss of generality, the collision operator can be approximated by the Bhatnagar-Gross-Krook (BGK) model as

$${f}_{i}^{*} ( x , t ) = {f}_{i} ( x , t ) + {Ω}_{i} ( f ) = {f}_{i} ( x , t ) - \frac{Δ t}{τ} [ {f}_{i} ( x , t ) - {f}_{i}^{eq} ( x , t ) ] ,$$

where τ is a relaxation time related to the molecular viscosity and ƒᵢ^{eq}(x,t) is the equilibrium distribution function.

Depending on whether a “push” or a “pull” method is implemented, the implementation of the streaming operation, and also how the algorithm's steps (streaming, collision, boundary conditions) are ordered within each time step of the lattice Boltzmann simulation, differs.

To complete one lattice Boltzmann time step involving collision, streaming, and boundary condition application, a two-pop (also called “one-step”) method can be used. In this implementation, two copies of the populations are maintained, one associated with post-collision “ƒ*” populations and the other with post-streaming “ƒ” populations. At the end of each iteration, ƒ* is swapped by ƒ for the next iteration and so on. The “push” and “pull” variants require different stacking of these operations. In the “push” method, for each time step the operations are ordered as 1) boundary conditions, 2) collision, and 3) streaming. In the “pull” method, for each time step the operations are ordered as 1) streaming, 2) boundary conditions, and 3) collision.

The boundary condition application step is analyzed in more detail with reference to lattice unit 200D in FIG. 2. At lattice units adjacent to the boundaries, such as lattice unit 200D in FIG. 2, some of the distribution functions are not available after the streaming step because they are meant to propagate from outside the computational domain to the inside of the computational domain, such as discretized space 134 in FIG. 2, to the inside of the computational domain. To correctly impose boundary conditions at these boundaries and to ensure the conservation of mass and momentum, these missing populations need to be reconstructed.

The bounce-back scheme is used as an example due to its simplicity. The bounce-back scheme can be used to enforce a no-slip boundary condition at a wall 260. In the bounce-back scheme, the populations are assumed to undergo a reflection at the wall 260, and thus be reflected back into the fluid domain 134 upon reaching the boundary wall 260.

The bounce-back can be implemented by swapping the outgoing populations along the lattice directions that are opposite to the missing incoming populations. For instance, in the D2Q9 lattice structure of FIG. 2 with a solid boundary 260 located at the “east” side of lattice unit 200D, there are three incoming populations shown with dashed arrows, corresponding to the “west” lattice direction, “northwest” direction, and “southwest” lattice direction (directions 0, 1, and 8, respectively). These incoming populations can be reconstructed using the outgoing distribution functions in the “cast”, “southeast”, and “northeast” lattice directions (directions 4, 6, and 3, respectively) shown in lattice unit 250D with solid arrows as ƒᵢ(x,t+Δt)=ƒ_{l̅}*(x,t), where τ indicates that e_{l̅} is in the opposite direction of eᵢ and again ƒᵢ* represents the post-collision distribution functions locally available at point x.

Unlike the simple bounce-back rule described above, the reconstruction process for managing boundary conditions in lattice Boltzmann methods becomes more involved when addressing more complex boundary conditions. The term “complex” boundary conditions is used to refer to boundary conditions requiring the storage and manipulation of auxiliary data, such as, for instance, interpolation data, prescribed values, direction of outgoing populations, previous-time step data, etc.

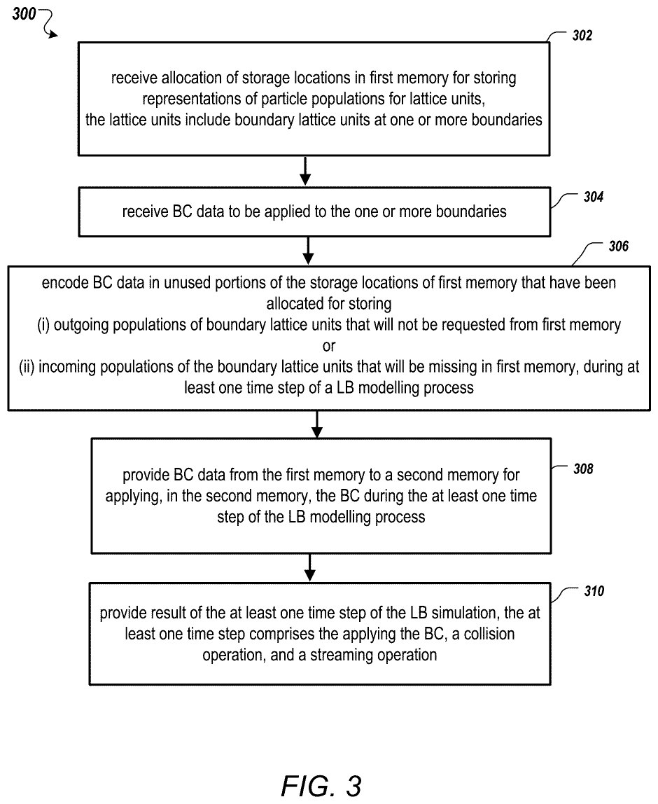

FIG. 3 is a flowchart of an example of a lattice Boltzmann modelling process 300 with boundary condition memory management. The method achieves an efficient encoding and decoding of boundary conditions data using allocated unused memory space to store the boundary conditions data for the lattice Boltzmann modelling process.

At 302, an allocation of storage locations in a first memory is received. The storage locations are used for storing representations of particle populations for respective lattice units of a discretized space, such as lattice units 200 of discretized space 134. Each particle population representation corresponds to each of a predetermined number of lattice vectors associated with different lattice directions, such as lattice vectors 250 of lattice units 200. The lattice units include boundary lattice units at one or more boundaries of the discretized space, such as boundary lattice unit 200D of discretized space 134. The first memory can be a random access memory (RAM) of a processing system.

At 304, boundary conditions data about one or more boundary conditions to be applied to the one or more boundaries of the discretized space is received. For example, boundary conditions data can include boundary conditions data to be applied at a wall 260 of discretized space 134.

At 306, boundary condition data is encoded in unused portions of the storage locations of the first memory that have been allocated for storing (i) outgoing populations of the boundary lattice units that will not be requested from the first memory or (ii) incoming populations of the boundary lattice units that will be missing in the first memory, during at least one time step of a lattice Boltzmann modelling process, as described in more detail below.

For example, the boundary conditions data can be Zou-He boundary conditions data and include a value of pressure or velocity to be applied at the wall. For example, the boundary conditions data can be no-slip boundary conditions data and include components of a velocity vector of a wall and/or distances to the wall for each lattice vector corresponding to a missing population. For example, the boundary conditions data can outflow boundary conditions data.

At 308, boundary conditions data from the first memory can be provided to a second memory for applying, in the second memory, the boundary conditions at the one or more boundaries during the at least one time step of the lattice Boltzmann modelling process, as described in more detail below. The second memory can be a local memory of the processing system. For example, the second memory can be a register memory of the processing system. The second memory can be thread registers of one or more graphical processing units (GPU) of a processing system. For example, the processing system can include multiple graphical processing units (GPU), and the second memory can include thread registers of the multiple graphical processing units (GPU).

At 310, a result of the at least one time step of the lattice Boltzmann modelling process can be provided. The at least one time step includes the applying the boundary conditions, a collision operation, and a streaming operation. The lattice Boltzmann modelling process can be used in a computational fluid dynamics process. The provided result can include a fluid density evolution in the discretized space. As described with reference to FIG. 1, providing a result of the at least one time step of the lattice Boltzmann modelling process can include storing the computer model 132 including discretized space 134 as a model document 130 and/or using it to generate another representation of the model (e.g., toolpath specifications for a manufacturing process for a structure or portions thereof) and/or providing it as a digital asset, such as for use in animation.

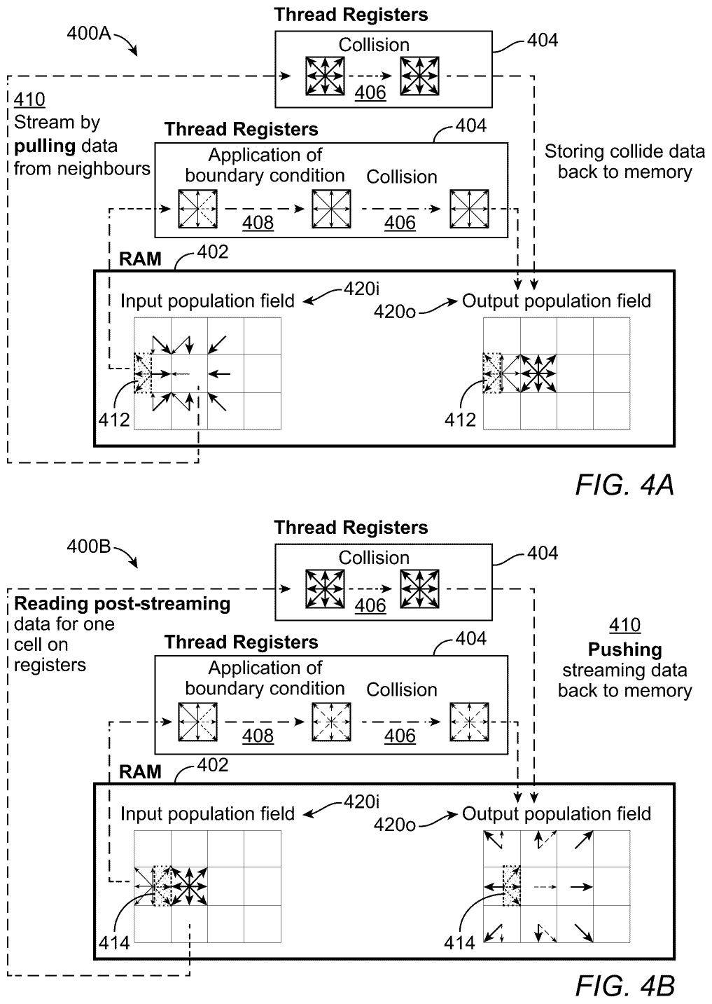

FIG. 4A and FIG. 4B are examples of implementations 400A, 400B of one time step of a lattice Boltzmann modelling process 300 with boundary condition memory management. FIG. 4A uses the “pull” method and FIG. 4B uses the “push” method.

In any case, as described above with reference to FIG. 3, two layers of computational memory are used. A first memory can be a random access memory (RAM) 402, where memory is allocated. A second memory, such as a local memory 404 of a processing system (e.g., a register memory of the processing system, thread registers 404, etc.), where low-level computational kernels are executed.

The collision operation 406 and the application of boundary conditions 408 are performed in the local memory, such as thread registers 402. The streaming operation 410 is conducted during the exchange of data between the RAM 402 and the thread registers 404.

In the pull method implementation 400A shown in FIG. 4A, the allocated memory for the known outgoing populations 412 at the boundary remain unutilized during a time step. In the pull method, streaming 410 is performed as the first step while transferring data from the RAM 402 to the registers 404. Once collision 406 and boundary condition application 408 are finalized, the original outgoing populations are not overwritten because, since they would leave the computational domain, the information they carry is irrelevant for the next iteration.

In the push method implementation 400B shown in FIG. 4B, the allocated memory for the missing incoming populations 414 at the boundary remain unutilized during a time step. In the push method, streaming 410 is performed as the last step while transferring data from the registers 404 to the RAM 402 and after performing the collision operation 406 and applying the boundary conditions 408. Therefore, the original incoming populations remain intact.

This available unutilized memory for boundary lattice units associated with different lattice directions (outgoing directions in the pull method and incoming directions in the push method) can be repurposed as additional storage for auxiliary data, such as auxiliary data needed for the implementation of some boundary conditions.

Both the push and pull methods can be implemented using two population fields: one input population field 420i and one output population field 420o. The two-field configuration guarantees that during a lattice Boltzmann iteration, all lattice units can be computed in parallel without any race conditions. Further, the two-population configuration makes available double the unused available storage space (input population and output population storage locations). This property holds both for the push and the pull methods.

The amount of unused storage available in the allocated memory for the outgoing populations for the pull method (incoming populations for the push method) depends on the lattice model and the specific boundary conditions employed in the simulation. For example, in the D2Q9 lattice model, there are 9 discrete velocity directions as shown in FIG. 2. For boundary nodes near a straight wall almost a third of these directions (e.g., the three directions 412 in FIG. 4A) will be associated with outgoing populations at the boundary nodes and remain unused. Moreover, the available storage can be doubled making use of the unused storage space in both the input and the output population fields 420i, 420o.

By re-purposing the memory allocated for the outgoing populations for the pull method (incoming populations for the push method), boundary conditions data (such as prescribed velocities, pressures, or other boundary-specific data) can be stored without the need for additional memory allocations. This reduces the memory footprint of lattice Boltzmann simulations. Further, this also enables kernel fusion as the auxiliary data is embedded in the same indexing schema defined by the populations fields.

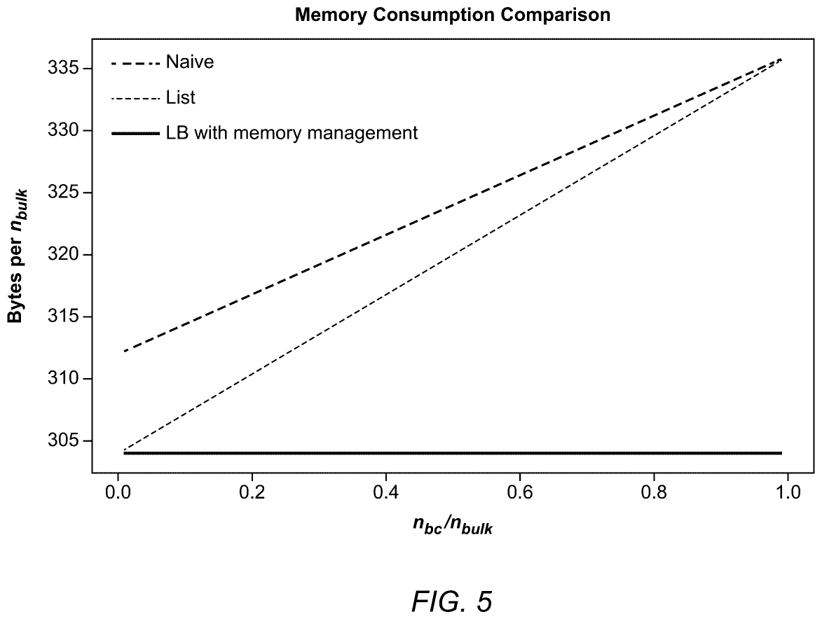

FIG. 5 shows a comparison of memory requirements (measured in number of floats needed) for a lattice Boltzmann method for a given simulation using different boundary condition storage methods. The dashed line corresponds to a naïve boundary condition storage method in which all the auxiliary data needed for the boundary conditions are stored in a separate array. The dotted line corresponds to a list-based boundary condition storage method in which the auxiliary boundary condition data for each type of boundary conditions (e.g., Zou-He, Bouzidi, etc.) are stored in a dedicated list. The solid line corresponds to the described memory management method using unused allocated memory storage locations. In the described method the memory consumption remains constant, irrespective of the ratio between the number of boundary lattice units (n_{bc}) and the number of non-boundary (or “bulk”) lattice units (n_{bulk}). This can become particularly important when simulating media such as porous media, where a substantial portion of the discretized fluid domain consists of boundary lattice units or voxels.

Further, in contrast to the naïve and list-based boundary condition methods, the described memory management strategy supports kernel fusion seamlessly. Kernel fusion in the lattice Boltzmann method can become especially challenging when dealing with complex boundary conditions that require auxiliary data for computations, such as the value of prescribed velocity or pressure. By storing boundary-related auxiliary data in the same memory locations as the populations, various kernels can be fused since the data required for different operations of the algorithm is readily available within the same kernel. Furthermore, since the boundary data are stored within the lattice Boltzmann population itself, a function computing a boundary condition can access data with maximum locality. This improved data locality enhances the overall performance of the fused lattice Boltzmann kernel, making the described method a more efficient and effective solution compared to the other boundary condition storage approaches.

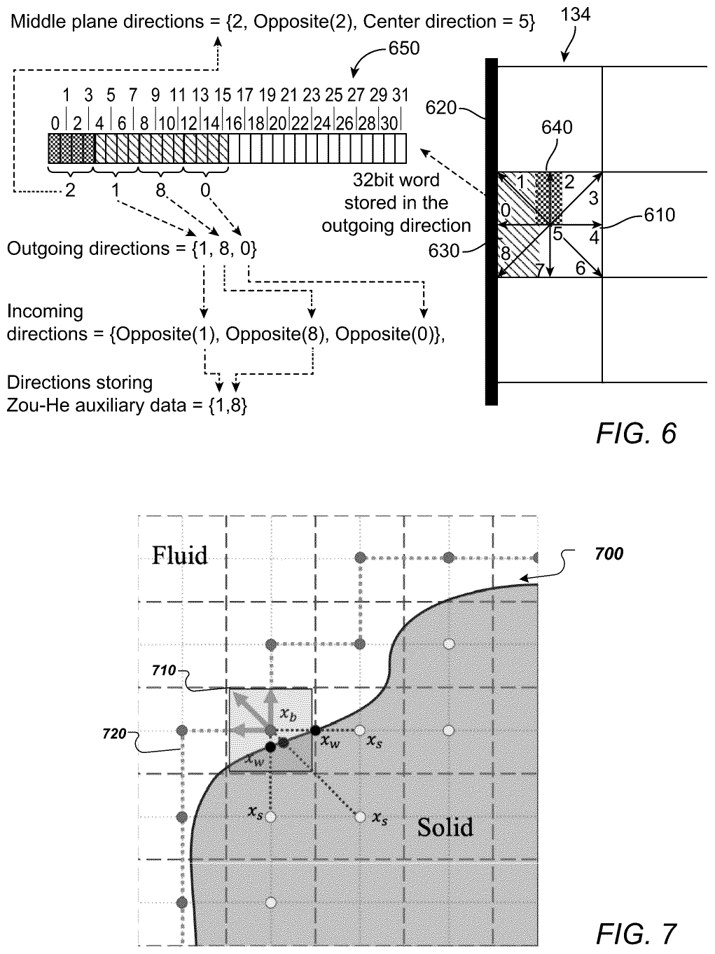

FIG. 6 shows an example of an encoding method for pressure or velocity boundary conditions at straight open boundaries. In order to prescribe a given pressure value or a velocity vector at a straight open boundary, methods such as the Zou-He method (Q. Zou and X. He, On pressure and velocity boundary conditions for the lattice Boltzmann bgk model, Physics of fluids, 9 (6), 1591 (1997)) or the Regularized method (J. Latt et al, Straight velocity boundaries in the lattice Boltzmann method, Phys. Rev. E, 77 (5), 056703 (2008)) can be used. Both Zou-He and the regularized method rely on the same auxiliary data. The same encoding/decoding strategy can be used with both methods. Without loss of generality, focus below is on the Zou-He method. The same type of encoding/decoding can be applied with the regularized method.

FIG. 6 shows a boundary lattice unit (also called voxel or cell herein) 610. Boundary cell 610 can be a cell contacting a wall 620 where a pressure or velocity are to be prescribed, such as a Zou-He boundary cell represented by a location x and eᵢ a vector normal to the wall representing the main direction where the straight domain boundary 620 is located (i.e., x+eᵢ is outside the discretized fluid domain 134). In the example of FIG. 6, the position of the wall is eᵢ=(−1, 0) and it is mapped in this example to the i^{th}=0^{th} lattice vector direction.

Like in each lattice unit (or fluid domain cell) of the discretized space, the lattice Boltzmann method associates the cell 610 with a floating point number for each lattice direction (namely, each cell population). However, because the cell 610 is a boundary cell (e.g., a Zou-He boundary cell), the outgoing populations 630 (populations 1, 8, 0 in the example of FIG. 6) are not used by the pull implementation of the lattice Boltzmann algorithm and their memory locations can therefore used to store necessary data to apply a pressure or velocity condition.

TABLE 1
Encoding of Regularized and Zou-He boundary conditions

| Encoding for the Regularized and Zou-He BC | D2Q9 | D3Q19 | D3Q27 |
|---|---|---|---|
| Lattice Geometry Features | | | |
| \|Q\|, where Q is the set of lattice directions | 9 | 19 | 27 |
| \|M\|, where M is the set of directions on the lattice middle plane | 3 | 9 | 9 |
| \|S\|, where S is the set of directions for storage per population field | 3 | 5 | 9 |
| L = 2 × \|S\|, storage directions for push and pull methods | 6 | 10 | 18 |
| Abstract Encoding Features | | | |
| Bᵢ = [log₂(\|Q\|)], # of bits to encode q ∈ [0, \|Q\| − 1] | 4 | 5 | 5 |
| n_{M}, # indices to reconstruct all q ∈ M | 1 | 4 | 4 |
| nₛ, #indices to encode all q ∈ S (note that nₛ = \|S\|) | 3 | 5 | 9 |
| B_{g} = (n_{M} + nₛ) Bᵢ, # bits to encode geometric features of the bc lattice | 16 | 45 | 65 |
| nₚ, # prescribed normal velocity or pressure values | 1 | 1 | 1 |
| Encoding for single precision (32-bit float) LBM simulation | | | |
| W_{g}³² = [B_{g}/32], # 32bit-words to encode M and S | 1 | 2 | 3 |
| Wₑ³² = W_{g}³² + nₚ, # 32bit-words to store full encoding | 2 | 3 | 4 |
| L ≥ Wₑ³² | valid | valid | valid |
| L − Wₑ³², # 32bit-words still available for storage | 4 | 7 | 14 |
| Encoding for double precision (64-bit float) LBM simulation | | | |
| W_{g}⁶⁴ = [B_{g}/64], # 64bit-words to encode Zou-He geometry | 1 | 1 | 2 |
| Wₑ⁶⁴ = W_{g}⁶⁴ + nₚ, # 64bit-words to store full encoding | 2 | 2 | 3 |
| L ≥ Wₑ⁶⁴ | valid | valid | valid |
| L − Wₑ⁶⁴, # 64bit-words still available for storage | 4 | 8 | 12 |

In the Lattice Geometry Feature section of Table 1 above, the symbol “L” represents the number of populations that the described method identifies as storage for different lattice geometries (D2Q9, D3Q19, D3Q27). The storage size of each direction depends on the precision used for the simulation, usually 32 or 64 bits. The size of the storage provided by the described method satisfies the storage requirements both in 32-bits and 64-bits.

In the example of FIG. 6, storage locations 650 in a memory of a processing system (e.g., in a random access memory of the processing system) are shown. The example of FIG. 6 shows storage locations 650 for a 32-bit floating point number corresponding to an unused outgoing population of a boundary lattice unit, the “0” population in this case. The location of the storage space is geometry dependent (i.e., it depends on the direction eᵢ corresponding to where the wall is located, i.e., the direction orthogonal to the wall). To simplify the encoding and decoding, the eᵢ wall direction can be provided as an input parameter for the process. The identification of eᵢ does not require any extra computation than is anyway required by lattice Boltzmann algorithms.

In some examples, the storage location corresponding to the population associated with the direction eᵢ where the wall is located (also called “main” outgoing direction) is used to store the geometry features of the boundary conditions data. The indexes of the outgoing populations 630 are represented with a diagonal pattern in FIG. 6. The incoming populations that must be reconstructed by, e.g., the Zou-He method, are opposite to the outgoing ones. The remaining populations are referred to as middle-plane (or mid-plane) populations.

To efficiently encode the geometry features, some geometric properties of a lattice can be leveraged. Firstly, the storage for the mid-plane directions can be compressed based on the following observations: the center direction (e.g., i=5 in FIG. 6) is always part of the middle-plane, so it does not need to be explicitly stored. The remaining mid-plane directions (e.g., directions 2 and 7 in FIG. 6) are symmetric, so only half of them need be stored, e.g., direction 640 corresponding to i=2 and shown in a dotted pattern in FIG. 6. In the example of FIG. 6, the middle plane directions can be compressed by storing only direction 2. Direction 7 is reconstructed as the opposite of direction 2. Direction 5 is just added as it is the center direction. In total, as summarized in Table 1, only n_{M}=1 direction needs to be stored to be able to reconstruct all the M directions of the lattice middle plane for a D2Q9 case.

The indexes of the outgoing directions can be naively stored. The indexes for the incoming populations do not need to be stored. These can be reconstructed as the opposite of the outgoing ones.

While the main direction eᵢ can be used to store the encoding for the geometry features, one single population may not be enough to store them: the encoding depends on the type of lattice as well as on the floating point type used by the simulation (e.g., 32 or 64 bits). When the population eᵢ is not enough, the next outgoing population in the order embedded in the encoding (i.e., reading the data from the direction eᵢ can provide the information about which outgoing direction to target for the rest of the encoding).

Lastly, the prescribed normal velocity or pressure value can be stored in the first outgoing direction that is not used to encode the geometry features. Pressure or velocity values are represented in the same floating point precision used for the lattice Boltzmann simulation. As such, they require the use of an entire population for storage.

A decoding process for a Zou-He boundary condition is shown in the pseudo-code below for a D2Q9 example, i.e., D=2 dimensions with Q=9 lattice directions. The Zou-He data stored in the main outgoing direction is extracted, e.g., from a 32-bit word, such as the one shown in FIG. 6). In particular, the incoming directions and the prescribed velocity uₙₒᵣₘ are extracted. This information is then used by the function “applyZouhe” to enforce the boundary condition.

```
const int D=2
const int Q=9;
const int sizeOfS = 3;
const int n_M = 1;
// Zou-He for a LBM Pull method
Void applyZouhePrescribedDensity(Cell cell, Population inPop, double popOnRegisters[Q]{
  int firstMaindOutgoingDirection = −1;
  //Loop over main directions (−x, −y, +y, +x)
  //Using same indexes as in picture
  const mainDirections [D*2] = {0,2,4,7};
  forEachDirection(maindirections, [&] (idx) {
    bool isAValidNeihgbour) = inPop.hasNeighbour(idx);
    if(!isAValidNeihgbour){
      firstMaindOutgoingDirection ==−1 : idx ? firstMaindOutgoingDirection;
      break;
    }
  });
  int outgoingDirections [sizeOfS];
  int incomingDirections [sizeOfs];
  int middlePlainDirections [n_M];
  decodeAndLoadOnRegisters(firstMaindOutgoingDirection,
    inPop,
    middlePlainDirections,
    IncomingDirections,
    outgoingDirections,
    popOnRegisters);
  double uNorm = inPop[outgoingDirections[1]];
  applyZouhe(incomingDirections, outgoingDirections, uNorm, outPop);
  return;
}
```

The information about the location of the boundary (i.e., the identification of the three classes of lattice directions: outgoing, incoming and middle-plane) can be extracted in other ways with a low impact in memory usage. For example, the three classes can be derived at runtime through some set operations. For example, outgoing directions can be detected as those directions pointing outside the domain, incoming population are the directions opposite to the outgoing ones, and finally the middle-plane includes all the directions that are not in the previous two classes. The overhead of executing such classification can be alleviated by encoding a table of all possible orientations of the boundary wall with respect to the lattice. For example, in 3D there are six possibilities. The configuration table would require a limited amount of static memory. Nevertheless, the described method provides more than enough available storage locations to store the classification directly within the allocated but unused populations data and therefore a more efficient memory access.

For stationary or moving curved walls, a no-slip boundary condition can be imposed by following, for instance, the bounce-back method or the Bouzidi scheme. Unlike other approaches such as the half-way bounce back method, the exact location of the wall with respect to the discretized domain can be taken into account. In essence, spatial interpolation is used to reconstruct the bounced-back distribution functions. Other schemes can be used to impose the no-slip condition. However other schemes have a non-local formulation, which require access to the information of neighbouring cells.

A fully-local interpolating bounce-back method based on single boundary node data can be expressed as ƒᵢ(x_{b},t+Δt)=a₁ƒ_{l̅}*(x_{b},t+Δt)+a₂ƒ_{l̅}*(x_{b},t)+a₃ƒᵢ*(x_{b},t)+K, where ƒᵢ(x_{b},t+Δt) indicates missing populations at a boundary node x_{b} for which x_{b}−eᵢ is a stationary or moving part of a solid geometry. The missing boundary populations are estimated by interpolating between their opposite known counterparts, ƒ_{l̅}*(x_{b},t+Δt), the post-collision population in the known direction, ƒ_{l̅}*(x_{b},t) and the post-collision population in the same missing direction, ƒ_{l̅}*(x_{b},t). Coefficients a₁, a₂, a₃ are interpolation coefficients. The last term is associated with contributions due to the wall velocity which may be zero or non-zero. Hence, K depends on the wall velocity vector K=K(u_{wall}).

The auxiliary information needed for the implementation of this boundary condition is thus the wall velocity, u_{wall} and the link-wise distance to the wall location along each missing direction defined as

$${γ}_{i} = \frac{\vert {x}_{b} - {x}_{w} \vert}{\vert {x}_{b} - {x}_{s} \vert} = \frac{\vert {x}_{b} - {x}_{w} \vert}{Δ t \vert {e}_{i} \vert} ,$$

where γᵢ can be used to determine the interpolation coefficients a₁, a₂, a₃. For example, γᵢ can appear explicitly in the interpolation coefficients a₁, a₂, @3.

FIG. 7 shows an example of a curved solid boundary 700 where an interpolating bounce-back boundary condition that takes into account the exact location of the wall can be imposed. The stair-step shape 720 corresponds to the boundary location that would be assumed by other approaches such as the standard half-way bounce back method.

FIG. 7 shows schematically how the link-wise distance, γᵢ, can be obtained using x_{w}, x_{b}, and xₛ, for a cell 710 on the curved boundary 700 that separates a fluid geometry from a solid geometry. For boundary nodes where both directions are missing (e.g., a corner node), the half-way bounce-back approximation can be used as ƒᵢ(x_{b},t+Δt)=ƒ_{l̅}*(x_{b},t)+K(u_{wall}). For these particular kinds of missing lattice directions, u_{wall} would be the only auxiliary information needed for the boundary conditions.

Insofar as a curved geometry is concerned, the number of outgoing populations (or incoming population in the push method) are not fixed unlike that for a straight wall. Nₒᵤₜ represents number of outgoing populations. These Nₒᵤₜ directions also indicate the missing directions for which there exists a solid neighbour by travelling towards eᵢ(xₛ=x_{b}+eᵢΔt) and there exists a fluid neighbour by travelling along −eᵢ(x_{ƒ}=x_{b}−eᵢΔt). Each boundary cell with Nₒᵤₜ missing neighbours needs to store N_{dim} components of u_{wall} as well as Nₒᵤₜ values of γᵢ. As a result, the total number of auxiliary values per boundary cell that should be stored efficiently for this scheme becomes Nₜₒₜ=N_{dim}+Nₒᵤₜ. Here N_{dim}=2 for 2D and N_{dim}=3 in 3D regardless of the chosen lattice.

If u_{wall}=0 at all the boundary voxels, there is sufficient space in the outgoing populations to encode Nₒᵤₜ values of γᵢ during the simulation initialization, since the number of required distances γᵢ is equal to the number of outgoing populations. For moving walls u_{wall} and γᵢ can be encoded at a lower precision. γᵢ is bounded from above and below and is always in the range [0, 1]. Furthermore, to avoid compressible effects, u_{wall} is much lower than the speed of sound, cₛ=sqrt(⅓)Δx/Δt, which in lattice Boltzmann units translates to u_{wall}<<sqrt(⅓). As a result of these conditions, when running the lattice Boltzmann simulation with double precision or 64 bits, a fixed point arithmetic with, for example, 16 bits can be adopted for representing both γᵢ and u_{wall}. For example, an 8-bit arithmetic can be adopted for representing both γᵢ and u_{wall} when running the lattice Boltzmann simulation with single precision or 32 bits.

Tables 2 and 3 summarize the resulting numerical accuracy for encoding the auxiliary information in two and three dimensions respectively. Although there are normally two population fields available for encoding and decoding purposes in the two-pop method, since this boundary condition requires the post-collision values of ƒ*, only one of the populations is available to store the necessary auxiliary data. Since all the data required to implement this class of boundary conditions, ƒ_{l̅}*(x_{b},t+Δt), ƒ_{l̅}*(x_{b},t), ƒᵢ*(x_{b},t) are readily available either in the RAM or in the thread registers, it is possible to fuse collision, streaming and BC operations as one kernel.

TABLE 2
Encoding for the 2D interpolating bounce-back scheme with moving walls

| Encoding for curved walls | Nₒᵤₜ = 1 | Nₒᵤₜ = 2 | Nₒᵤₜ ≥ 3 |
|---|---|---|---|
| Geometry Features | | | |
| N_{dim} | 2 | 2 | 2 |
| N_{γ} = Nₒᵤₜ, number of γ values | 1 | 2 | i |
| uⱼ range, (j ϵ 0, N_{dim} −1) | [−0.1, 0.1] | [−0.1, 0.1] | [0.1, 0.1] |
| γᵢ range, (i ϵ 0, Nₒᵤₜ −1) | [0, 1] | [0, 1] | [0, 1] |
| Encoding for LBM on 64 bit | | | |
| sₐ: available bits for storage | 64 + 64 | 128 + 64 | 64 × (i + 1) |
| bᵤⱼ = bits per uⱼ value | 42 | 48 | $\vert \frac{64 \times ( i + 1 )}{{N}_{d i m} + {N}_{γ}} \vert > 32$ |
| b_{γi} = bits per γᵢ value | 42 | 48 | $\vert \frac{64 \times ( i + 1 )}{{N}_{d i m} + {N}_{γ}} \vert > 32$ |
| pᵤⱼ = precision of uⱼ values | 4.5474e−14 | 7.105e−16 | $\frac{2 \times 0.1}{{2}^{{b}_{u j}} - 1}$ |
| p_{γi} = precision of γᵢ values | 2.2727e−13 | 3.5527e−15 | $\frac{1}{{2}^{{b}_{γ i}} - 1}$ |
| Encoding for LBM on 32 bit | | | |
| sₐ: available bits for storage | 32 + 32 | 64 + 32 | 32 × (i + 1) |
| bᵤⱼ = bits per uⱼ value | 21 | 24 | $\vert \frac{32 \times ( i + 1 )}{{N}_{d i m} + {N}_{γ}} \vert > 32$ |
| b_{γi} = bits per γᵢ value | 21 | 24 | $\vert \frac{32 \times ( i + 1 )}{{N}_{d i m} + {N}_{γ}} \vert > 32$ |
| pᵤⱼ = precision of uⱼ values | 9.5367e−08 | 1.1920e−08 | $\frac{2 \times 0.1}{{2}^{{b}_{u j}} - 1}$ |
| p_{γi} = precision of γᵢ values | 4.7683e−07 | 5.9604e−08 | $\frac{1}{{2}^{{b}_{γ i}} - 1}$ |

TABLE 3
Encoding for the 3D interpolating bounce-back scheme with moving walls

| Encoding for curved walls | Nₒᵤₜ = 1 | Nₒᵤₜ = 2 | Nₒᵤₜ ≥ 3 |
|---|---|---|---|
| Geometry Features | | | |
| N_{dim} | 3 | 3 | 3 |
| N_{γ} = Nₒᵤₜ, number of γ values | 1 | 2 | i |
| uⱼ range, (j ϵ 0, N_{dim} −1) | [−0.1, 0.1] | [−0.1, 0.1] | [0.1, 0.1] |
| γᵢ range, (i ϵ 0, Nₒᵤₜ −1) | [0, 1] | [0, 1] | [0, 1] |
| Encoding for LBM | | | |
| simulation on 64 bit | | | |
| sₐ: available bits for storage | 64 + 64 | 128 + 64 | 64 × (i + 1) |
| bᵤⱼ = bits per uⱼ value | 32 | 38 | $\vert \frac{64 \times i}{{N}_{d i m} + {N}_{γ}} \vert > 32$ |
| b_{γi} = bits per γᵢ value | 32 | 38 | $\vert \frac{64 \times i}{{N}_{d i m} + {N}_{γ}} \vert > 32$ |
| pᵤⱼ = precision of uⱼ values | 4.6566e−11 | 7.2759e−13 | $\frac{2 \times 0.1}{{2}^{{b}_{u j}} - 1}$ |
| p_{γi} = precision of γᵢ values | 2.3283e−10 | 3.6379e−12 | $\frac{1}{{2}^{{b}_{γ i}} - 1}$ |
| Encoding for LBM simulation | | | |
| on 32 bit | | | |
| sₐ: available bits for storage | 32 + 32 | 64 + 32 | 32 × (i + 1) |
| bᵤⱼ = bits per uⱼ value | 16 | 19 | $\vert \frac{64 \times i}{{N}_{d i m} + {N}_{γ}} \vert > 32$ |
| b_{γi} = bits per γᵢ value | 16 | 19 | $\vert \frac{64 \times i}{{N}_{d i m} + {N}_{γ}} \vert > 32$ |
| pᵤⱼ = precision of uⱼ values | 3.0518e−06 | 3.8147e−07 | $\frac{2 \times 0.1}{{2}^{{b}_{u j}} - 1}$ |
| p_{γi} = precision of γᵢ values | 1.5259e−05 | 1.9073e−06 | $\frac{1}{{2}^{{b}_{γ i}} - 1}$ |

Outflow boundary conditions can be employed in simulating external flows. Zero gradient along the flow direction can be assumed in order to minimize the influence of the artificial computational boundary on the interior flow field. Various techniques can be used to impose outflow boundary conditions. For example, a method that aims to reduce the acoustic reflections that involves interpolation both in space and time (e.g., M. Geier et al, The cumulant lattice Boltzmann equations in three dimensions: Theory and validation, Computers & Mathematics with Applications, 70(4), 507 (2015)).

Based on this method, the missing populations at the boundary cell can be determined as

$${f}_{i} ( {x}_{b} , t + Δ t ) = {f}_{i} ( {x}_{b} + {e}_{i} Δ t , t ) ( {c}_{s} - {u}_{b} ) \frac{Δ t}{Δ x} + ( 1 - ( {c}_{s} - {u}_{b} ) \frac{Δ t}{Δ x} ) ) {f}_{i} ( {x}_{b} + {e}_{i} Δ t , t + Δ t ) ,$$

where u_{b} is the flow velocity at x_{b}. Populations ƒᵢ(x_{b}+eᵢΔt,t), ƒᵢ(x_{b}+eᵢΔt,t+Δt) refer to populations of immediate neighboring cells during two consecutive time steps. The neighboring fluid cell is located at x_{ƒ}=x_{b}+eᵢΔt, the next immediate neighbor along each missing direction eᵢ.

This expression can be simplified after considering that velocities must be much lower than the speed of sound (u<<cₛ) for accurate simulations of incompressible flows due to the increased compressibility errors as u tends to the speed of sound Hence, the above equation can be rewritten as

$${f}_{i} ( {x}_{b} , t + Δ t ) = {f}_{i} ( {x}_{b} + {e}_{i} Δ t , t ) {c}_{s} \frac{Δ t}{Δ x} + ( 1 - {c}_{s} \frac{Δ t}{Δ x} ) {f}_{i} ( {x}_{b} + {e}_{i} Δ t , t + Δ t ) .$$

This equation requires non-local data access. The proposed single node local formulation tracks the non-local information back to x_{b}. In other words, the streaming operation may be invoked to reformulate the above equation as

$${f}_{i} ( {x}_{b} , t + Δ t ) = {f}_{i}^{*} ( {x}_{b} , t - Δ t ) {c}_{s} \frac{Δ t}{Δ x} + ( 1 - {c}_{s} \frac{Δ t}{Δ x} ) {f}_{i}^{*} ( {x}_{b} , t ) .$$

As a result, the required ingredients to impose this boundary condition for each boundary cell are the dynamically changing post-collision populations at x_{b} based on the previous and current time steps, ƒᵢ*(x_{b},t−Δt), ƒᵢ*(x_{b},t). While the post-collision population in the current time step is readily available in the memory, the previous time step value need to be encoded and decoded dynamically. For this boundary condition, the post-collision populations in the previous time step is the auxiliary value that requires to be efficiently stored. In order to encode post-collision populations of the previous time step, the storage space that is available but unused in the outgoing population based on the pull method or the incoming population based on the push method can be used.

Because the proposed reformulation of the outflow boundary condition leads to a single-node and local boundary condition that can be specified using local information at x_{b}, and also due to the described efficient storage of the previous post-collision values in the outgoing direction of the same boundary node, the streaming, collision, and boundary condition application can be used and implemented in one kernel.

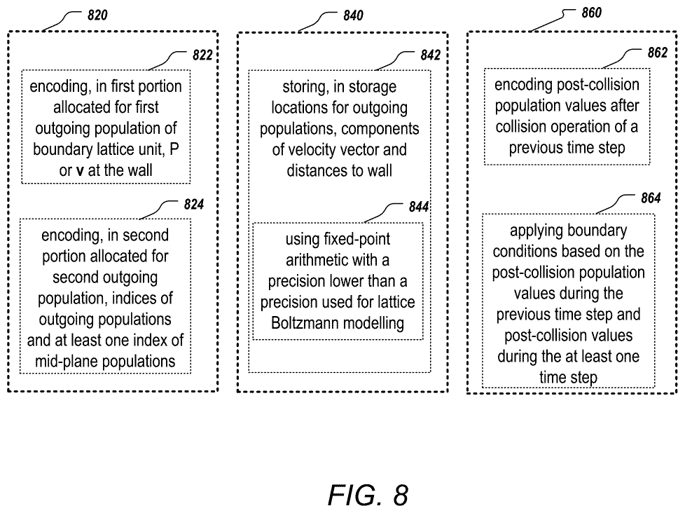

FIG. 8 shows flowcharts of lattice Boltzmann modelling processes for different boundary conditions. Method 820 can be used for pressure or velocity boundary conditions at straight open walls. The boundary conditions data can include a vector indicating a location of a wall and a value of a pressure or velocity to be applied at the wall.

Encoding the boundary conditions data in the unused portions of the storage locations of the first memory can include encoding 822, in a first portion allocated for storing a first outgoing population of a boundary lattice unit, the value of the pressure or velocity to be applied at the wall.

Encoding the boundary conditions data in unused portions of the storage locations of the first memory can include encoding 824, in a second portion allocated for storing a second outgoing population of a boundary lattice unit, indices corresponding to lattice vectors of outgoing populations and at least one index corresponding to directions of mid-plane populations.

Method 840 can be used for no-slip boundary conditions. The boundary conditions data can include components of a velocity vector of a wall and/or distances to the wall for each lattice vector corresponding to a missing population

Encoding the boundary conditions data in unused portions of the storage locations of the first memory can include storing 842, in storage locations allocated for storing the outgoing populations, the components of the velocity vector and the distances to the wall.

The components of the velocity vector of the wall and the distances to the wall can be encoded 844 using fixed-point arithmetic with a precision lower than a precision used for the at least one step of the lattice Boltzmann modelling process.

Method 860 can be used for outflow boundary conditions. Encoding, in unused allocated storage locations of the first memory, boundary conditions data can include encoding 862, for the at least one time step of the lattice Boltzmann modelling process, post-collision population values obtained after a collision operation of a previous time step of the lattice Boltzmann modelling process. Applying the boundary conditions at the one or more boundaries during the at least one time step of the lattice Boltzmann modelling process can include applying 864 the boundary conditions based on the post-collision population values obtained during the previous time step and post-collision values obtained during the at least one time step.

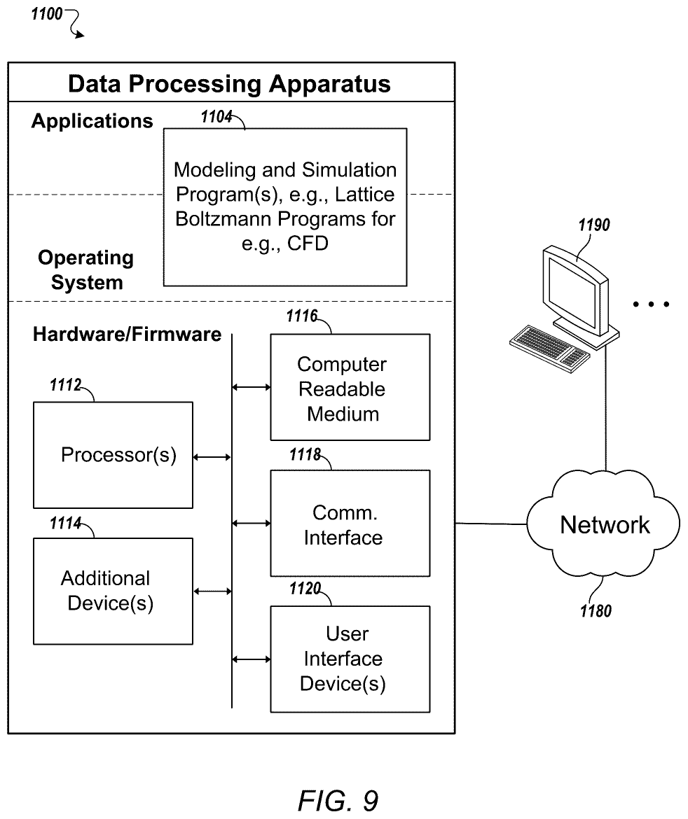

FIG. 9 is a schematic diagram of a data processing system including a data processing apparatus 1100, which can be programmed as a client or as a server. The data processing apparatus 1100 is connected with one or more computers 1190 through a network 1180. While only one computer is shown in FIG. 9 as the data processing apparatus 1100, multiple computers can be used. The data processing apparatus 1100 includes various software modules, which can be distributed between an applications layer and an operating system. These can include executable and/or interpretable software programs or libraries, including tools and services of one or more programs 1104, as described above. Thus, the modeling and simulation program(s) 1104 can be program(s) 1104 for lattice Boltzmann modeling processes (such as program(s) 116) for e.g., computational fluid dynamics and can implement efficient memory encoding/decoding as described. Further, the program(s) 1104 can potentially implement manufacturing control operations (e.g., generating and/or applying toolpath specifications to effect manufacturing of designed objects). The number of software modules used can vary from one implementation to another. Moreover, the software modules can be distributed on one or more data processing apparatus connected by one or more computer networks or other suitable communication networks.

The data processing apparatus 1100 also includes hardware or firmware devices including one or more processors 1112, one or more additional devices 1114, a computer readable medium 1116, a communication interface 1118, and one or more user interface devices 1120. Each processor 1112 is capable of processing instructions for execution within the data processing apparatus 1100. In some implementations, the processor 1112 is a single or multi-threaded processor. Each processor 1112 is capable of processing instructions stored on the computer readable medium 1116 or on a storage device such as one of the additional devices 1114. The data processing apparatus 1100 uses the communication interface 1120 to communicate with one or more computers 1190, for example, over the network 1180. Examples of user interface devices 1120 include a display, a camera, a speaker, a microphone, a tactile feedback device, a keyboard, a mouse, and VR and/or AR equipment. The data processing apparatus 1100 can store instructions that implement operations associated with the program(s) described above, for example, on the computer readable medium 1116 or one or more additional devices 1114, for example, one or more of a hard disk device, an optical disk device, a tape device, and a solid state memory device.

Embodiments of the subject matter and the functional operations described in this specification can be implemented in digital electronic circuitry, or in computer software, firmware, or hardware, including the structures disclosed in this specification and their structural equivalents, or in combinations of one or more of them. Embodiments of the subject matter described in this specification can be implemented using one or more modules of computer program instructions encoded on a non-transitory computer-readable medium for execution by, or to control the operation of, data processing apparatus. The computer-readable medium can be a manufactured product, such as hard drive in a computer system or an optical disc sold through retail channels, or an embedded system. The computer-readable medium can be acquired separately and later encoded with the one or more modules of computer program instructions, e.g., after delivery of the one or more modules of computer program instructions over a wired or wireless network. The computer readable medium can be a machine-readable storage device, a machine-readable storage substrate, a memory device, or a combination of one or more of them.

The term “data processing apparatus” encompasses all apparatus, devices, and machines for processing data, including by way of example a programmable processor, a computer, or multiple processors or computers. The apparatus can include, in addition to hardware, code that creates an execution environment for the computer program in question, e.g., code that constitutes processor firmware, a protocol stack, a database management system, an operating system, a runtime environment, or a combination of one or more of them. In addition, the apparatus can employ various different computing model infrastructures, such as web services, distributed computing and grid computing infrastructures.

A computer program (also known as a program, software, software application, script, or code) can be written in any suitable form of programming language, including compiled or interpreted languages, declarative or procedural languages, and it can be deployed in any suitable form, including as a standalone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, subprograms, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive), to name just a few. Devices suitable for storing computer program instructions and data include all forms of non-volatile memory, media and memory devices, including by way of example semiconductor memory devices, e.g., EPROM (Erasable Programmable Read-Only Memory), EEPROM (Electrically Erasable Programmable Read-Only Memory), and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, embodiments of the subject matter described in this specification can be implemented on a computer having a display device, e.g., an LCD (liquid crystal display) display device, an OLED (organic light emitting diode) display device, or another monitor, for displaying information to the user, and a keyboard and a pointing device, e.g., a mouse or a trackball, by which the user can provide input to the computer. Other kinds of devices can be used to provide for interaction with a user as well; for example, feedback provided to the user can be any suitable form of sensory feedback, e.g., visual feedback, auditory feedback, or tactile feedback; and input from the user can be received in any suitable form, including acoustic, speech, or tactile input.

The computing system can include clients and servers. A client and server are generally remote from each other and typically interact through a communication network. The relationship of client and server arises by virtue of computer programs running on the respective computers and having a client-server relationship to each other. Embodiments of the subject matter described in this specification can be implemented in a computing system that includes a backend component, e.g., as a data server, or that includes a middleware component, e.g., an application server, or that includes a frontend component, e.g., a client computer having a graphical user interface or a browser user interface through which a user can interact with an implementation of the subject matter described is this specification, or any combination of one or more such backend, middleware, or frontend components. The components of the system can be interconnected by any suitable form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

While this specification contains many implementation details, these should not be construed as limitations on the scope of what is being or may be claimed, but rather as descriptions of features specific to particular embodiments of the disclosed subject matter. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Thus, particular embodiments of the invention have been described. Other embodiments are within the scope of the following claims. In addition, actions recited in the claims can be performed in a different order and still achieve desirable results.

What is claimed is:

1. A method comprising:
receiving an allocation of storage locations in a first memory, wherein the storage locations are used for storing representations of particle populations for respective lattice units of a discretized space, each particle population representation corresponding to each of a predetermined number of lattice vectors associated with different lattice directions, wherein the first memory is a random access memory of a processing system, and the lattice units include boundary lattice units at one or more boundaries of the discretized space;
receiving boundary conditions data about one or more boundary conditions to be applied to the one or more boundaries of the discretized space;
encoding the boundary condition data in unused portions of the storage locations of the first memory that have been allocated for storing (i) outgoing populations of the boundary lattice units that will not be requested from the first memory or (ii) incoming populations of the boundary lattice units that will be missing in the first memory, during at least one time step of a lattice Boltzmann modelling process;
providing the boundary conditions data from the first memory to a second memory for applying, in the second memory, the boundary conditions at the one or more boundaries during the at least one time step of the lattice Boltzmann modelling process, wherein the second memory is a local memory of the processing system; and
providing a result of the at least one time step of the lattice Boltzmann modelling process, wherein the at least one time step comprises the applying the boundary conditions, a collision operation, and a streaming operation.

2. The method of claim 1, wherein
the boundary conditions data comprises a vector indicating a location of a wall and a value of a pressure or velocity to be applied at the wall; and wherein
encoding the boundary conditions data in the unused portions of the storage locations of the first memory comprises encoding, in a first portion allocated for storing a first outgoing population of a boundary lattice unit, the value of the pressure or velocity to be applied at the wall.

3. The method of claim 2, wherein encoding the boundary conditions data in unused portions of the storage locations of the first memory comprises encoding, in a second portion allocated for storing a second outgoing population of a boundary lattice unit, one or more indices corresponding to lattice vectors of outgoing populations and at least one index corresponding to directions of mid-plane populations.

4. The method of claim 3, wherein providing the boundary conditions data from the first memory to the second memory for applying, in the second memory, the boundary conditions at the one or more boundaries during the at least one step of the lattice Boltzmann modelling process comprises
decoding, from the first portion, the value of the pressure or velocity, and
decoding, from the second portion, based on the encoded indices, indices corresponding to outgoing populations, mid-plane populations, and incoming populations.

5. The method of claim 1, wherein
the boundary conditions data comprises components of a velocity vector of a wall and/or distances to the wall for each lattice vector corresponding to a missing population; and wherein
encoding the boundary conditions data in unused portions of the storage locations of the first memory comprises storing, in storage locations allocated for storing the outgoing populations, the components of the velocity vector and the distances to the wall.

6. The method of claim 5, wherein the components of the velocity vector of the wall and the distances to the wall are encoded using fixed-point arithmetic with a precision lower than a precision used for the at least one step of the lattice Boltzmann modelling process.

7. The method of claim 1, wherein encoding, in unused allocated storage locations of the first memory, boundary conditions data comprises
encoding, for the at least one time step of the lattice Boltzmann modelling process, post-collision population values obtained after a collision operation of a previous time step of the lattice Boltzmann modelling process.

8. The method of claim 7, wherein applying the boundary conditions at the one or more boundaries during the at least one time step of the lattice Boltzmann modelling process comprises applying the boundary conditions based on the post-collision population values obtained during the previous time step and post-collision values obtained during the at least one time step.

9. The method of claim 1, wherein, during the at least one time step of the lattice Boltzmann modelling process, the applying the boundary conditions, the collision operation, and the streaming operation are performed together by a computational kernel that merges boundary condition handling with collision and streaming operations.

10. The method of claim 1, wherein the lattice Boltzmann modelling process is used in a computational fluid dynamics process, and the provided result comprises a fluid density evolution in the discretized space.

11. The method of claim 1, wherein the local memory is close enough to a processor of the processing system so that the local memory is connected to a system bus of an integrated circuit chip on or in which the processor is built.

12. The method of claim 11, wherein the local memory comprises a register memory or a cache memory of the processing system.

13. The method of claim 1, wherein the processing system comprises multiple GPUs, and the second memory comprises thread registers of the multiple GPUs.

14. A system comprising:
one or more processors;
a random access memory coupled with the one or more processors; and
a local memory coupled with the one or more processors;
wherein the one or more processors are configured to
receive an allocation of storage locations in the random access memory, wherein the storage locations are used for storing representations of particle populations for respective lattice units of a discretized space, each particle population representation corresponding to each of a predetermined number of lattice vectors associated with different lattice directions, wherein the lattice units include boundary lattice units at one or more boundaries of the discretized space,
receive boundary conditions data about one or more boundary conditions to be applied to the one or more boundaries of the discretized space,
encode the boundary condition data in unused portions of the storage locations of the random access memory that have been allocated for storing (i) outgoing populations of the boundary lattice units that will not be requested from the random access memory or (ii) incoming populations of the boundary lattice units that will be missing in the random access memory, during at least one time step of a lattice Boltzmann modelling process,
provide the boundary conditions data from the random access memory to the local memory for applying, in the local memory, the boundary conditions at the one or more boundaries during the at least one time step of the lattice Boltzmann modelling process, and
provide a result of the at least one time step of the lattice Boltzmann modelling process, wherein the at least one time step comprises the applying the boundary conditions, a collision operation, and a streaming operation.

15. The system of claim 14, wherein the boundary conditions data comprises a vector indicating a location of a wall and a value of a pressure or velocity to be applied at the wall; and wherein
the one or more processors are configured to encode, in a first portion allocated for storing a first outgoing population of a boundary lattice unit, the value of the pressure or velocity to be applied at the wall.

16. The system of claim 15, wherein the one or more processors are configured to encode, in a second portion allocated for storing a second outgoing population of a boundary lattice unit, one or more indices corresponding to lattice vectors of outgoing populations and at least one index corresponding to directions of mid-plane populations.

17. The system of claim 16, wherein the one or more processors are configured to provide the boundary conditions data from the random access memory to the local memory for applying, in the local memory, the boundary conditions at the one or more boundaries during the at least one step of the lattice Boltzmann modelling process by being configured to
decode, from the first portion, the value of the pressure or velocity, and
decode, from the second portion, based on the encoded indices, indices corresponding to outgoing populations, mid-plane populations, and incoming populations.

18. The system of claim 14, wherein
the boundary conditions data comprises components of a velocity vector of a wall and/or distances to the wall for each lattice vector corresponding to a missing population; and wherein
the one or more processors are configured to encode the boundary conditions data in unused portions of the storage locations of the first memory by being configured to store, in storage locations allocated for storing the outgoing populations, the components of the velocity vector and the distances to the wall.

19. The system of claim 18, wherein the components of the velocity vector of the wall and the distances to the wall are encoded using fixed-point arithmetic with a precision lower than a precision used for the at least one step of the lattice Boltzmann modelling process.

20. The system of claim 14, wherein the one or more processors are configured to encode, in unused allocated storage locations of the first memory, boundary conditions data by being configured to encode, for the at least one time step of the lattice Boltzmann modelling process, post-collision population values obtained after a collision operation of a previous time step of the lattice Boltzmann modelling process.

21. The system of claim 20, wherein applying the boundary conditions at the one or more boundaries during the at least one time step of the lattice Boltzmann modelling process comprises applying the boundary conditions based on the post-collision population values obtained during the previous time step and post-collision values obtained during the at least one time step.

22. The system of claim 14, wherein, during the at least one time step of the lattice Boltzmann modelling process, the applying the boundary conditions, the collision operation, and the streaming operation are performed together by a computational kernel that merges boundary condition handling with collision and streaming operations.

23. The system of claim 14, wherein the lattice Boltzmann modelling process is used in a computational fluid dynamics process, and the provided result comprises a fluid density evolution in the discretized space.

24. The system of claim 14, wherein the local memory is close enough to at least one of the one or more processors so that the local memory is connected to a system bus of an integrated circuit chip on or in which the at least one of the one or more processors is built.

25. The system of claim 24, wherein the local memory comprises a register memory or a cache memory of the at least one of the one or more processors.

26. The system of claim 14, wherein the one or more processors comprises multiple GPUs, and the local memory comprises thread registers of the multiple GPUs.

27. A non-transitory computer-readable medium tangibly encoding instructions that, when executed, cause one or more processors to perform method operations comprising:
receiving an allocation of storage locations in a first memory, wherein the storage locations are used for storing representations of particle populations for respective lattice units of a discretized space, each particle population representation corresponding to each of a predetermined number of lattice vectors associated with different lattice directions, wherein the first memory is a random access memory of the processing system, and the lattice units include boundary lattice units at one or more boundaries of the discretized space;
receiving boundary conditions data about one or more boundary conditions to be applied to the one or more boundaries of the discretized space;
encoding the boundary condition data in unused portions of the storage locations of the first memory that have been allocated for storing (i) outgoing populations of the boundary lattice units that will not be requested from the first memory or (ii) incoming populations of the boundary lattice units that will be missing in the first memory, during at least one time step of a lattice Boltzmann modelling process;
providing the boundary conditions data from the first memory to a second memory for applying, in the second memory, the boundary conditions at the one or more boundaries during the at least one time step of the lattice Boltzmann modelling process, wherein the second memory is a local memory of the processing system; and
providing a result of the at least one time step of the lattice Boltzmann modelling process, wherein the at least one time step comprises the applying the boundary conditions, a collision operation, and a streaming operation.

28. The non-transitory computer-readable medium of claim 27, wherein
the boundary conditions data comprises a vector indicating a location of a wall and a value of a pressure or velocity to be applied at the wall; and wherein
encoding the boundary conditions data in the unused portions of the storage locations of the first memory comprises encoding, in a first portion allocated for storing a first outgoing population of a boundary lattice unit, the value of the pressure or velocity to be applied at the wall.

29. The non-transitory computer-readable medium of claim 28, wherein encoding the boundary conditions data in unused portions of the storage locations of the first memory comprises encoding, in a second portion allocated for storing a second outgoing population of a boundary lattice unit, one or more indices corresponding to lattice vectors of outgoing populations and at least one index corresponding to directions of mid-plane populations.

30. The non-transitory computer-readable medium of claim 29, wherein providing the boundary conditions data from the first memory to the second memory for applying, in the second memory, the boundary conditions at the one or more boundaries during the at least one step of the lattice Boltzmann modelling process comprises
decoding, from the first portion, the value of the pressure or velocity, and
decoding, from the second portion, based on the encoded indices, indices corresponding to outgoing populations, mid-plane populations, and incoming populations.

31. The non-transitory computer-readable medium of claim 27, wherein
the boundary conditions data comprises components of a velocity vector of a wall and/or distances to the wall for each lattice vector corresponding to a missing population; and wherein
encoding the boundary conditions data in unused portions of the storage locations of the first memory comprises storing, in storage locations allocated for storing the outgoing populations, the components of the velocity vector and the distances to the wall.

32. The non-transitory computer-readable medium of claim 31, wherein the components of the velocity vector of the wall and the distances to the wall are encoded using fixed-point arithmetic with a precision lower than a precision used for the at least one step of the lattice Boltzmann modelling process.

33. The non-transitory computer-readable medium of claim 27, wherein encoding, in unused allocated storage locations of the first memory, boundary conditions data comprises
encoding, for the at least one time step of the lattice Boltzmann modelling process, post-collision population values obtained after a collision operation of a previous time step of the lattice Boltzmann modelling process.

34. The non-transitory computer-readable medium of claim 33, wherein applying the boundary conditions at the one or more boundaries during the at least one time step of the lattice Boltzmann modelling process comprises applying the boundary conditions based on the post-collision population values obtained during the previous time step and post-collision values obtained during the at least one time step.

35. The non-transitory computer-readable medium of claim 27, wherein, during the at least one time step of the lattice Boltzmann modelling process, the applying the boundary conditions, the collision operation, and the streaming operation are performed together by a computational kernel that merges boundary condition handling with collision and streaming operations.

36. The non-transitory computer-readable medium of claim 27, wherein the lattice Boltzmann modelling process is used in a computational fluid dynamics process, and the provided result comprises a fluid density evolution in the discretized space.

37. The non-transitory computer-readable medium of claim 27, wherein the local memory is close enough to a processor of the processing system so that the local memory is connected to a system bus of an integrated circuit chip on or in which the processor is built.

38. The non-transitory computer-readable medium of claim 37, wherein the local memory comprises a register memory or a cache memory of the processing system.

39. The non-transitory computer-readable medium of claim 27, wherein the processing system comprises multiple GPUs, and the second memory comprises thread registers of the multiple GPUS.
